(19) United States
(12) Patent Application Publication
(10) Pub. No.: US 2014/0262498 A1
(43) Pub. Date: Sep. 18, 2014

(54) Interconnect Device and Assemblies Made Therewith

(71) Applicant: U.S.A. as represented by the Administrator of the National Aeronautics and Space Administration, (US)

(72) Inventors: Jim D. Hester, Arab, AL (US); Stephen Mark Strickland, Athens, AL (US); James F. Blanche, Hazel Green, AL (US); Garry D. McGuire, Huntsville, AL (US)

(73) Assignee: U.S.A. as represented by the Administrator of the National Aeronautics and Space Administration, Washington, DC (US)

(21) Appl. No.: 13/800,692

(22) Filed: Mar. 13, 2013

(51) Int. Cl. H01R 4/02

(52) U.S. Cl. CPC H01R 4/02
USPC 174/84 R

(57) ABSTRACT

An interconnect device forms an electrical and mechanical connection between electrical connections pads on an integrated circuit and those on a printed circuit board. The device is a coil with a first portion of its turns at one axial end of the coil having at least two turns in axial contact with one another, a second portion of its turns at an opposing axial end of the coil having at least two turns in axial contact with one another, and a third portion of the turns disposed between and contiguous with the first and second portions. The third portion is defined by at least two of the turns in a spaced apart axial relationship. The coil is made from a spring material and is electrically conductive. Each of the coil's first portion and second portion is coated with a solder material.

### ORIGIN OF THE INVENTION

The invention described herein was made in the performance of work under a NASA contract and by employees of the United States Government and is subject to the provisions of Section 305 of the National Aeronautics and Space Act of 1958, as amended, Public Law 85-568 (72 Stat. 435, 42 U.S.C. §2457), and may be manufactured and used by or for the Government for governmental purposes without the payment of any royalties thereon or therefore.

### BACKGROUND OF THE INVENTION

1. Field of the Invention

This invention relates to electrical interconnect devices. More specifically, the invention is an interconnect device used in the formation of an electrical and mechanical connection between an integrated circuit and a printed circuit board.

2. Description of the Related Art

Integrated circuits (ICs) are “packages” typically fabricated from silicon chip circuits encased in plastic or silicon chip circuits encased in ceramic. Regardless of the casing material, ICs having interconnections over the entire bottom surface of the casing are referred to as area array devices. Printed circuit boards (PCB's) to which ICs are mounted are typically constructed of organic materials such as epoxy glass, polyimide, etc., as is known in the art. The coefficient of thermal expansion differences that exist between ICs and a PCB can be the source of failure at the (solder) interconnections between the ICs and the PCB. This is especially true for electronic assemblies using area array devices that are subjected to large and frequent thermal excursions (often encountered in space environments). In these situations, interconnections are subject to early failure due to fatigue caused by thermally induced shear stresses on the interconnections. Since the coefficient of thermal expansion mismatch exists for both plastic-encased and ceramic-encased ICs with the greater mismatch existing for ceramic-encased ICs, this is a significant problem.

Area array devices typically utilize electrically conductive balls or columns for the above-described interconnections. Compliance of the interconnections in response to shear stress is a function of standoff height and interconnection material, and affects how the system responds to thermal fatigue. Current state-of-the-art utilizes solder columns for such interconnections. The disadvantages of column-type interconnections include limited compliance, fragility of solder, difficulty in manufacturing and assembly, and difficulty or impossibility of rework.

### SUMMARY OF THE INVENTION

Accordingly, it is an object of the present invention to provide an interconnect device that can be used in the formation of an electrical and mechanical connection between an area array integrated circuit package and a printed circuit board.

Another object of the present invention is to provide an interconnect device that can be used in the formation of an electrical and mechanically compliant connection between an area array integrated circuit package and an organic-material printed circuit board.

Other objects and advantages of the present invention will become more obvious hereinafter in the specification and drawings.

In accordance with the present invention, an interconnect device is provided for use in forming an electrical and mechanical connection between electrical connections pads on an area array integrated circuit and those on a printed circuit board. The device is a coil defined by a plurality of turns. A first portion of the turns at one axial end of the coil has at least two turns in axial contact with one another. A second portion of the turns at an opposing axial end of the coil also has at least two turns in axial contact with one another. A third portion of the turns is disposed between and is contiguous with the first and second portions. The third portion is defined by at least two of the turns in a spaced apart axial relationship. The coil is made from a spring material and is electrically conductive. Each of the coil's first portion and second portion is coated with a solder material.

### BRIEF DESCRIPTION OF THE DRAWING(S)

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a side view of an interconnect device in accordance with an embodiment of the present invention;

FIG. 2 is an axial cross-sectional view of the interconnect device in accordance with an embodiment of the present invention;

FIG. 3 is an axial cross-sectional view of an interconnect device in accordance with another embodiment of the present invention;

FIG. 4 is a side view of an area array integrated circuit assembly that includes interconnect devices of the present invention; and

FIG. 5 is a side view of a portion of an electronic assembly in which interconnect devices of the present invention are used to electrically and mechanically connect to an area array integrated circuit assembly to an organic-material printed circuit board in accordance with the present invention.

### DESCRIPTION OF THE PREFERRED EMBODIMENT(S)

Referring now to the drawings and more particularly to FIG. 1, an interconnect device in accordance with an embodiment of the present invention is shown and is referenced generally by numeral 10. In general, interconnect device 10 will be used to electrically and mechanically couple an electrical pad exposed on the surface of an integrated circuit (not shown) and an electrical pad exposed on the surface of an organic-material printed circuit board (not shown). As will be explained further below, interconnect device 10 provides for rigid coupling to both the integrated circuit (IC) and printed circuit board (PCB). Simultaneously, interconnect device 10 provides for mechanical compliance to absorb shear stresses due to the thermal coefficient mismatch between the IC and PCB as well as vibration/shock stresses that can occur.

Interconnect device 10 is a coil defined by a number of turns formed about an air-filled core or region. For purpose of the present invention, the coil is defined by three contiguous portions illustrated in their static or unstressed state. Specifically, interconnect device 10 is defined by opposing axial end portions 12 and 16 with a central portion 14 disposed between end portions 12 and 16. Each of end portions 12 and 16 is formed by multiple turns that are in full contact with one another in the axial dimension of interconnect device 10. That is, the tangentially contacting turns are in contact for a full 360 degrees. In the illustrated example, turns 12A and 12B are in axial contact to define end portion 12 and turns 16A and 16B are in axial contact to define end portion 16. The axially contacting turns of interconnect device 10 define inactive regions (i.e., mechanically rigid) of interconnect device 10. It is to be understood that each end portion of interconnect device 10 could contain more than two axially contacting turns without departing from the scope of the present invention.

Central portion 14 is disposed between and is contiguous with end portions 12 and 16. In general, central portion 14 is formed by multiple turns that are axially separated from one another. In the illustrated example, turns 14A-14D are axially separated. These axially separated turns of interconnect device 10 define active regions (i.e., mechanically compliant) of interconnect device 10. It is to be understood that the number of axially separated turns used to form central portion 14 can be more or less than illustrated without departing from the scope of the present invention.

Since the coil structure of interconnect device 10 must provide electrical interconnectivity while being mechanically compliant in central portion 14, interconnect device 10 must be electrically conductive and incorporate spring material. By way of an illustrative example, a beryllium copper wire can be used to form the multiple turns of interconnect device 10. However, it is to be understood that other electrically-conductive alloys could be used without departing from the scope of the present invention.

To facilitate the use of interconnect device 10 in electronic assembly fabrication, the outer surface of all or some of interconnect device 10 is formed by a solder material such as a composition of tin-lead, solder material compositions that are lead-free, etc. For example, interconnect device 10 can be a wire coil 11 (e.g., a beryllium copper wire) entirely coated or plated with a solder material 20 as illustrated in the cross-sectional view presented in FIG. 2. However, since only end portions 12 and 16 are used for solder connectivity (to an IC or PCB) as will be explained later below, it may be sufficient to coat or plate only end portions 12 and 16 as illustrated in FIG. 3.

Referring now to FIG. 4, an IC assembly that includes interconnect devices of the present invention is shown and is referenced generally by numeral 100. In general, IC assembly 100 includes an IC 102 and a plurality of interconnect devices 10. IC 102 is an integrated circuit package having an outer casing 102A made from a plastic material, a ceramic material, or other casing material known in the art. The circuit construction and function of IC 102 are not limitations of the present invention.

IC 102 is an area array device having a number of electric pads 102B exposed at a surface of casing 102A where pads 102B are the termination points for circuits maintained in IC 102 as is well known in the art. However, IC 102 does not have solder balls coupled to each of pads 102B as is the case with prior art area array ICs. Instead, each pad 102B has one of interconnect devices 10 electrically and mechanically coupled thereto. More specifically, a layer of solder paste 102C is applied to each pad 102B prior to the placement of an interconnect device 10 thereon. Then, IC 102 with interconnection devices 10 thereon are heated so that solder paste 102C and solder material 20 on one end (e.g., end portion 12 in the illustrated example) of each device 10 flow and bond as would be understood by one of ordinary skill in the art. Note that solder material 20 and solder paste 102C are delineated in FIG. 4 to facilitate illustration and description of the present invention. By virtue of the above-described construction, IC assembly 100 has interconnect “points” that are both mechanically rigid and mechanically compliant. That is, the inactive-coil portion of each interconnect device defines a rigid solder column, whereas the active-coil portion of each interconnect device is mechanically compliant to absorb shear, vibration, and/or shock stresses.

Referring now to FIG. 5, a portion of an electronic assembly fabricated using at least one IC assembly 100 is shown and is referenced generally by numeral 200. In general, electronic assembly 200 includes an organic-material (e.g., glass epoxy, polyimide, etc.) PCB 202 and at least one IC assembly 100. PCB 202 has a number of electric pads 202A exposed at a surface of PCB 202. Although not illustrated in FIG. 5, it is well known that electric pads 202A serve as the end points of electric runs/circuits (not shown) maintained within and/or on PCB 202. The free inactive-coil end regions 16 of interconnect devices 10 are soldered to pads 202A that have solder paste 202B applied thereto in ways well understood in the art. Note that solder material 20, solder paste 102C and solder paste 202B are delineated in FIG. 5 to facilitate illustration and description of the present invention. As a result of this construction, the inactive-coil ends of each interconnect device 10 form rigid solder “columns” attached respectively to IC 102 and PCB 202, while the active-coil portions of each interconnect device 10 provide for mechanical compliance.

The advantages of the present invention are numerous. The interconnect devices, as well as the IC assemblies and electronic assemblies fabricated using the interconnect devices, greatly improve product performance and useful life by greatly reducing failure between ICs and PCBs. This is especially true in the case of ceramic-substrate ICs that must be mounted on organic-material PCBs for applications subject to thermal expansion/contraction stresses, vibration stresses, and shock stresses.

Although the invention has been described relative to a specific embodiment thereof, there are numerous variations and modifications that will be readily apparent to those skilled in the art in light of the above teachings. For example, the outboard end of each interconnect device could be ground to define a ring-shaped planar surface for improved contact with the surface to which they will be soldered. It is therefore to be understood that, within the scope of the appended claims, the invention may be practiced other than as specifically described.

What is claimed as new and desired to be secured by Letters Patent of the United States is:

1. An interconnect device, comprising:
a coil defined by a plurality of turns, a first portion of said plurality of turns at one axial end of said coil, a second portion of said plurality of turns at an opposing axial end of said coil, and a third portion of said plurality of turns disposed between and contiguous with said first portion and said second portion;
each of said first portion and said second portion defined by at least two of said plurality of turns in axial contact with one another;
said third portion defined by at least two of said plurality of turns in a spaced apart axial relationship;
said coil being made from a spring material;
said coil being electrically conductive; and
each of said first portion and said second portion being coated with a solder material, wherein said first portion is adapted to be soldered to an electrical pad exposed on an area array integrated circuit and said second portion is adapted to be soldered to an electrical pad exposed on an organic-material printed circuit board.

2. An interconnect device as in claim 1, wherein said coil is entirely coated with said solder material.

3. An interconnect device as in claim 1, wherein said first solder material comprises a composition of tin-lead.

4. An interconnect device as in claim 1, wherein said coil is formed from beryllium copper wire.

5. An interconnect device, comprising:
an electrically-conductive alloy coil defined by a plurality of turns and coated with a solder material, a first portion of said plurality of turns at one axial end of said coil, a second portion of said plurality of turns at an opposing axial end of said coil, and a third portion of said plurality of turns disposed between and contiguous with said first portion and said second portion;
each of said first portion and said second portion defined by at least two of said plurality of turns in axial contact with one another, said first portion adapted to be soldered to an electrical pad exposed on an area array integrated circuit and said second portion adapted to be soldered to an electrical pad exposed on an organic-material printed circuit board;
said third portion defined by at least two of said plurality of turns in a spaced apart axial relationship; and
said coil being made from a spring material.

6. An interconnect device as in claim 5, wherein said solder material comprises a composition of tin-lead.

7. An interconnect device as in claim 5, wherein said electrically conductive alloy comprises beryllium copper.

8. An interconnect device for use in forming an electrical and mechanical connection between an electrical connection pad of an integrated circuit and an electrical connection pad on a printed circuit board, comprising:
a coil defined by a plurality of turns formed about an air-filled core region wherein a first portion of said plurality of turns is at one axial end of said coil, a second portion of said plurality of turns is at an opposing axial end of said coil, and a third portion of said plurality of turns is disposed between and is contiguous with said first portion and said second portion;
each of said first portion and said second portion defined by at least two of said plurality of turns in axial contact with one another;
said third portion defined by at least two of said plurality of turns in a spaced apart axial relationship;
said coil being made from a spring material;
said coil being electrically conductive;
each of said first portion and said second portion being coated with a solder material wherein each of said first portion and said second portion define a hollow column, and wherein said first portion so-coated is adapted to be soldered to an electrical pad of an integrated circuit and said second portion so-coated is adapted to be soldered to an electrical pad of an organic-material printed circuit board.

9. An interconnect device as in claim 8, wherein said coil is entirely coated with said solder material.

10. An interconnect device as in claim 8, wherein said solder material comprises a composition of tin-lead.

11. An interconnect device as in claim 8, wherein said coil is formed from beryllium copper wire.

12. An integrated circuit assembly, comprising:
an area array integrated circuit having a casing with a plurality of electrical connection pads exposed at a surface of said casing; and
a plurality of interconnect devices coupled to said area array integrated circuit,
each of said interconnect devices comprising a coil defined by a plurality of turns wherein a first portion of said plurality of turns is at one axial end of said coil, a second portion of said plurality of turns is at an opposing axial end of said coil, and a third portion of said plurality of turns is disposed between and is contiguous with said first portion and said second portion,
wherein, for each said coil, said first portion and said second portion are defined by at least two of said plurality of turns in axial contact with one another, said third portion is defined by at least two of said plurality of turns in a spaced apart axial relationship, said first portion and said second portion are coated with a solder material, and said first portion so-coated is soldered to one of said electrical connection pads,
each said coil being made from a spring material, and each said coil being electrically conductive.

13. An interconnect device as in claim 12, wherein each said coil is entirely coated with said solder material.

14. An interconnect device as in claim 12, wherein said solder material comprises a composition of tin-lead.

15. An interconnect device as in claim 12, wherein each said coil is formed from beryllium copper wire.

16. An electronic assembly, comprising:
at least one area array integrated circuit, each said area array integrated circuit having a casing with a plurality of electrical connection pads exposed at a surface of said casing;
an organic-material printed circuit board with a plurality of electrical connection pads exposed at a surface thereof; and
a plurality of interconnect devices coupled to each said area array integrated circuit and said organic-material printed circuit board, each of said interconnect devices soldered to one of said electrical connection pads,
each of said interconnect devices comprising a coil defined by a plurality of turns wherein a first portion of said plurality of turns is at one axial end of said coil, a second portion of said plurality of turns is at an opposing axial end of said coil, and a third portion of said plurality of turns is disposed between and is contiguous with said first portion and said second portion,
wherein, for each said coil, said first portion and said second portion are defined by at least two of said plurality of turns in axial contact with one another, said third portion is defined by at least two of said plurality of turns in a spaced apart axial relationship, said first portion and said second portion are coated with a solder material, said first portion so-coated is soldered to one of said electrical connection pads exposed on said surface of said casing, and said second portion so-coated is soldered to one of said electrical connection pads exposed at said surface of said organic-material printed circuit board,
each said coil being made from a spring material, and
each said coil being electrically conductive.

17. An electronic assembly as in claim 16, wherein each said coil is entirely coated with said solder material.

18. An electronic assembly as in claim 16, wherein said solder material comprises a composition of tin-lead.

19. An electronic assembly as in claim 16, wherein each said coil is formed from beryllium copper wire.
